(19) United States
(12) Patent Application Publication
(10) Pub. No.: US 2025/0336914 A1
(43) Pub. Date: Oct. 30, 2025

(54) POSITIVE ELECTRODE AND SECONDARY BATTERY

(71) Applicant: MURATA MANUFACTURING CO., LTD., Kyoto (JP)

(72) Inventors: Masaaki ITOU, Kyoto (JP); Takuya NAKASHIMA, Kyoto (JP)

(21) Appl. No.: 19/090,631

(22) Filed: Mar. 26, 2025

(30) Foreign Application Priority Data
Apr. 25, 2024 (JP) 2024-071789
Jan. 20, 2025 (JP) 2025-007985

(51) Int. Cl. H01M 4/131; H01M 4/02; H01M 4/505; H01M 4/525; H01M 4/62; H01M 10/0525

(52) U.S. Cl. CPC H01M 4/131; H01M 4/505; H01M 4/525; H01M 4/623; H01M 4/625; H01M 10/0525; H01M 2004/021; H01M 2004/028

(57) ABSTRACT

A positive electrode includes a positive electrode active material containing a plurality of first particles and a plurality of second particles having an average particle diameter smaller than an average particle diameter of the plurality of first particles, and letting a resistance of the plurality of first particles be R1 and a resistance of the plurality of second particles be R2 as measured using a scanning spreading resistance microscope, a ratio (log R2/log R1) of logarithms of the resistance (R1) of the plurality of first particles and the resistance (R2) of the plurality of second particles is 1.25 or less.

### CROSS REFERENCE TO RELATED APPLICATIONS

The present application claims priority to Japanese Patent Application No. 2025-007985, filed on Jan. 20, 2025, and Japanese Patent Application No. 2024-071789, filed on Apr. 25, 2024, the entire contents of which are incorporated herein by reference.

### BACKGROUND

The present disclosure relates to a positive electrode and a secondary battery.

A lithium ion secondary batteries is disclosed including a positive electrode, a negative electrode, and a non-aqueous electrolyte.

### SUMMARY

The present disclosure relates to a positive electrode and a secondary battery.

As for lithium ion secondary batteries, it is required to improve battery characteristics such as cycle characteristics. A technique is disclosed for regulating the spreading resistance when the cross section or the surface of the positive electrode active material is measured with a spreading resistance microscope within an appropriate range. However, the spreading resistance for each particle contained in the positive electrode active material is not considered.

The present disclosure, in an embodiment, relates to providing a positive electrode and a secondary battery capable of improving battery characteristics.

A positive electrode according to an embodiment includes a positive electrode active material containing a plurality of first particles and a plurality of second particles having an average particle diameter smaller than an average particle diameter of the plurality of first particles, and letting a resistance of the plurality of first particles be R1 and a resistance of the plurality of second particles be R2 as measured using a scanning spreading resistance microscope, a ratio (log R2/log R1) of logarithms of the resistance (R1) of the plurality of first particles and the resistance (R2) of the plurality of second particles is 1.25 or less.

A secondary battery according to an embodiment includes the above positive electrode, a negative electrode, and an electrolyte.

With the positive electrode and the secondary battery of the present disclosure, battery characteristics can be improved.

### BRIEF DESCRIPTION OF THE FIGURES

FIG. 1 is a sectional view illustrating the configuration of a secondary battery according to an embodiment;

FIG. 2 is a sectional view illustrating the configuration of a wound electrode body according to an embodiment;

FIG. 3 is a schematic view illustrating a section of a positive electrode active material layer according to an embodiment;

FIG. 4 is a schematic view illustrating a section of a positive electrode active material layer according to a comparative example;

FIG. 5 is an explanatory view for explaining the particle size distribution of a positive electrode active material according to an embodiment;

FIG. 6 is an explanatory view for explaining another example of the particle size distribution of a positive electrode active material according to an embodiment;

FIG. 7 is a graph schematically showing the resistance distributions of first particles and second particles according to an embodiment and the comparative example;

FIG. 8 is a flowchart for explaining a method for producing a positive electrode active material layer according to Examples 1 and 2;

FIG. 9 is a flowchart for explaining a method for producing a positive electrode active material layer according to Comparative Example 1;

FIG. 10 is a flowchart for explaining a method for producing a positive electrode active material layer according to Comparative Example 2; and

FIG. 11 is a flowchart for explaining a method for producing a positive electrode active material layer according to Examples 3, 4, 5, and 6 and Comparative Examples 3 and 4.

### DETAILED DESCRIPTION

Hereinafter, the present disclosure will be described in further detail according to an embodiment. The present disclosure is not limited thereto an embodiment.

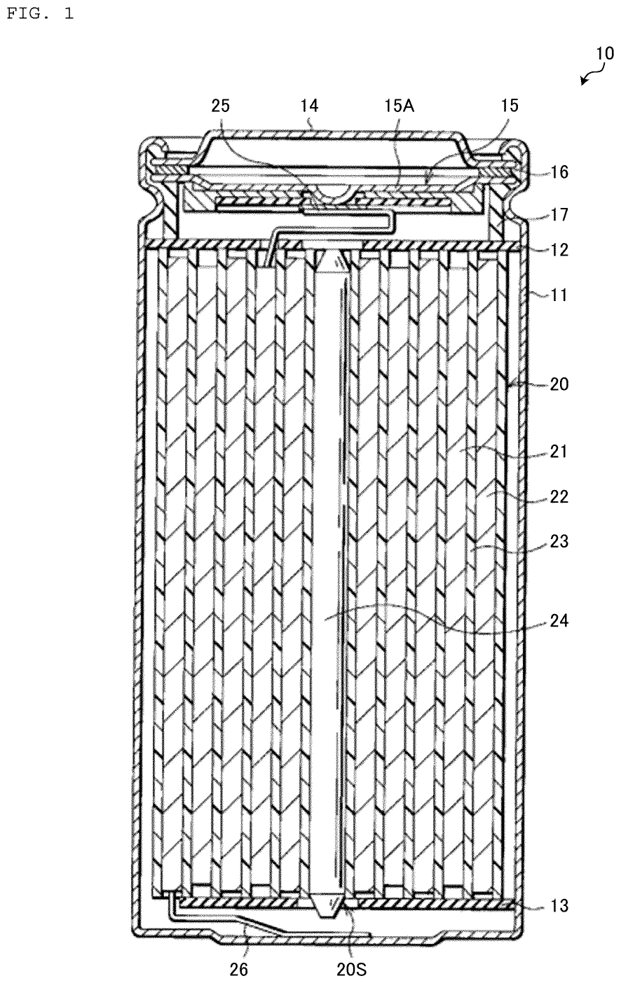

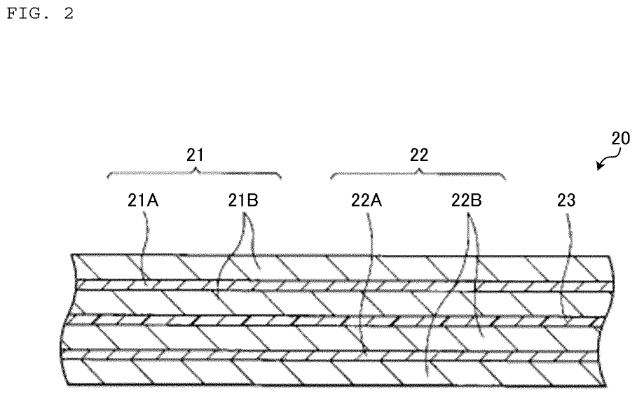

FIG. 1 is a sectional view illustrating the configuration of a secondary battery according to an embodiment. FIG. 2 is a sectional view illustrating the configuration of a wound electrode body according to an embodiment. A secondary battery 10 according to an embodiment is a secondary battery using lithium as an electrode reactant and is a lithium ion secondary battery in which the battery capacity is obtained using the lithium (Li) insertion/extraction.

As illustrated in FIG. 1, the secondary battery 10 according to an embodiment includes a battery can 11, a pair of insulating plates 12 and 13, a wound electrode body 20, a positive electrode lead 25, and a negative electrode lead 26. The secondary battery 10 is a cylindrical secondary battery in which the wound electrode body 20, which is a battery element, is housed inside the battery can 11 having a cylindrical shape.

The battery can 11 is cylindrical and has a hollow structure in which one end portion is closed and the other end portion is opened. The battery can 11 is formed of, for example, iron (Fe), aluminum (Al), or an alloy thereof. The battery can 11 may have a configuration in which the surface of iron (Fe) is plated with nickel (Ni) or the like.

The wound electrode body 20 is housed inside the battery can 11. The wound electrode body 20 is, for example, one in which a positive electrode 21 and a negative electrode 22 (see FIG. 2) are laminated with a separator 23 interposed therebetween and then wound.

The pair of insulating plates 12 and 13 are disposed, for example, so as to sandwich the wound electrode body 20 therebetween as well as to extend in a direction perpendicular to the wound peripheral surface of the wound electrode body 20.

A battery cover 14, a safety valve mechanism 15, and a heat sensitive resistance element (PTC element) 16 are crimped to the open end portion of the battery can 11 with a gasket 17 interposed therebetween. As a result, the open end portion of the battery can 11 is sealed. The battery cover 14 is formed of, for example, a material similar to that of the battery can 11. The safety valve mechanism 15 and the heat sensitive resistance element 16 are provided inside the battery cover 14, and the safety valve mechanism 15 is electrically connected to the battery cover 14 with the heat sensitive resistance element 16 interposed therebetween.

In this safety valve mechanism 15, when the internal pressure exceeds a certain level due to an internal short circuit or heating from the outside, a disk plate is inverted to disconnect the electrical connection between the battery cover 14 and the wound electrode body 20. The heat sensitive resistance element 16 prevents abnormal heat generation due to a large current, and the resistance of the heat sensitive resistance element 16 increases as the temperature increases.

The gasket 17 is formed of, for example, an insulating material, and may have a surface coated with asphalt.

A center pin 24 is inserted into the winding center of the wound electrode body 20. However, the center pin 24 may be omitted.

The positive electrode lead 25 formed of a conductive material such as aluminum is connected to the positive electrode 21. The positive electrode lead 25 is connected to the safety valve mechanism 15 by welding or the like, and electrically connected to the battery cover 14 with the safety valve mechanism 15 interposed therebetween. The negative electrode lead 26 formed of a conductive material such as nickel is connected to the negative electrode 22. The negative electrode lead 26 is electrically connected to the battery can 11 by welding or the like.

As illustrated in FIG. 2, the positive electrode 21 includes a positive electrode current collector 21A and two positive electrode active material layers 21B provided on both surfaces of the positive electrode current collector 21A. However, only one positive electrode active material layer 21B may be provided on one surface of the positive electrode current collector 21A.

The positive electrode current collector 21A contains, for example, any one or more types of conductive materials such as aluminum, nickel, and stainless steel. The positive electrode current collector 21A may be formed of a single layer, or may be formed of multiple layers.

The positive electrode active material layer 21B contains a positive electrode active material capable of occluding and releasing lithium. The positive electrode active material layer 21B contains a positive electrode active material, a positive electrode binder, and a positive electrode conductive aid. The positive electrode active material layer 21B is not limited to the materials described above, and may contain a dispersant and the like.

The positive electrode active material is preferably a lithium-containing compound such as a lithium-containing composite oxide. The lithium-containing composite oxide is an oxide containing lithium and one or more elements other than lithium as constituent elements. The lithium-containing composite oxide has, for example, a layered rock-salt type or spinel type crystal structure.

The positive electrode active material may be one type or a combination of a plurality of types, and in the case of a plurality of types, the compound species (elementary composition, coating element, dopant species, or the like) and form (secondary particles, primary particles, or the like) of the positive electrode active materials to be combined may be any compound species and form. The positive electrode active material is, for example, a nickel-based positive electrode active material. The nickel-based positive electrode active material is, for example, lithium nickel cobalt manganate (NCM), and is a lithium-containing compound containing nickel (Ni), cobalt (Co), and manganese (Mn), which are transition metal elements, as constituent elements.

Specific examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15} (Mn_{0.65}Ni_{0.22}Co_{0.13}) O₂, LiMn₂O₄, and LiFePO₄.

The positive electrode binder contained in the positive electrode active material layer 21B may be an arbitrary material, and contains, for example, one or more of synthetic rubbers and polymer compounds. Examples of the synthetic rubbers include styrene-butadiene-based rubber, fluorine-based rubber, and ethylene propylene diene. Examples of the polymer compounds include polyvinylidene fluoride and a polyimide.

The positive electrode conductive aid contained in the positive electrode active material layer 21B may be an arbitrary material, and contains, for example, carbon. Examples of the carbon include graphite, carbon black, acetylene black, Ketjen black, carbon nanotubes, and graphene. The positive electrode conductive aid contained in the positive electrode active material layer 21B is not limited to those as long as it is a material having conductivity, and may be another carbon material, a metal material, a conductive polymer, or the like.

The negative electrode 22 includes a negative electrode current collector 22A and two negative electrode active material layers 22B provided on both surfaces of the negative electrode current collector 22A. However, only one negative electrode active material layer 22B may be provided on one surface of the negative electrode current collector 22A.

The negative electrode current collector 22A contains, for example, any one or more types of conductive materials such as aluminum, nickel, and stainless steel. The negative electrode current collector 22A may be formed of a single layer, or may be formed of multiple layers.

The negative electrode active material layer 22B contains a negative electrode active material capable of occluding and releasing lithium. The negative electrode active material layer 22B contains a negative electrode active material, a negative electrode binder, and a negative electrode conductive aid. The negative electrode active material layer 22B is not limited to the materials described above, and may contain a dispersant and the like.

The negative electrode active material includes, for example, a material capable of occluding and releasing lithium, such as a carbon material, a metal, a metalloid, an alloy or a compound of silicon, or an alloy or a compound of tin (Sn).

Examples of the carbon material that can be used as the negative electrode active material include graphite, non-graphitizable carbon, and graphitizable carbon. More specifically, examples of the carbon material include pyrolytic carbons, cokes, glass-shaped carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as phenol resin and furan resin at an appropriate temperature to carbonize.

Examples of the metal and the metalloid that can be used as the negative electrode active material include tin, lead (Pb), aluminum, indium (In), silicon, zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Of these, silicon, germanium, tin, and lead are preferable. In addition, silicon and tin are more preferable because of having a high ability to occlude and release lithium and allowing a high energy density.

Examples of the alloy of silicon that can be used as the negative electrode active material include alloys containing at least one from the group consisting of tin, nickel, copper (Cu), iron (Fe), cobalt (Co), manganese (Mn), zinc, indium, silver, titanium (Ti), germanium, bismuth, antimony, and chromium (Cr) as the second constituent element other than silicon. Examples of the compound of silicon that can be used as the negative electrode active material include a compound including oxygen (O) or Carbon©, and the compound may include the above-described second constituent element in addition to silicon.

Examples of the alloy of tin that can be used as the negative electrode active material include alloys including at least one from the group consisting of silicon, nickel, copper, iron, cobalt, manganese, zinc, indium, silver, titanium, germanium, bismuth, antimony, and chromium as the second constituent element other than tin. Examples of the compound of tin that can be used as the negative electrode active material include those including oxygen or carbon, and the compound of tin may include the above-mentioned second constituent elements in addition to tin.

The negative electrode binder contained in the negative electrode active material layer 22B may be an arbitrary material, and contains, for example, one or more of synthetic rubbers and polymer compounds. Examples of the synthetic rubbers include styrene-butadiene-based rubber, fluorine-based rubber, and ethylene propylene diene. Examples of the polymer compounds include polyvinylidene fluoride and a polyimide.

The negative electrode conductive aid contained in the negative electrode active material layer 22B may be an arbitrary material, and contains, for example, carbon. Examples of the carbon include graphite, carbon black, acetylene black, and Ketjen black. The negative electrode conductive aid contained in the negative electrode active material layer 22B is not limited to those as long as it is a material having conductivity, and may be a metal material, a conductive polymer, or the like.

The separator 23 separates the positive electrode 21 and the negative electrode 22, and allows lithium ions to pass while preventing a short circuit of current caused by contact of both electrodes. In the example shown in FIG. 2, the separator 23 is provided between the positive electrode active material layer 21B of the positive electrode 21 and the negative electrode active material layer 22B of the negative electrode 22.

The material of the separator 23 is preferably electrically stable, is chemically stable against the positive electrode active material, the negative electrode active material, and the electrolytic solution, and has an insulating property. As the separator 23, for example, a layer made of a polymer nonwoven fabric, a porous film, glass, or ceramic fibers can be used. The material of the separator 23 more preferably includes a porous polyolefin film. Thereby, the safety of the battery can be improved due to the short circuit preventing effect and the shutdown effect.

The separator 23 is impregnated with the electrolytic solution. In the example of FIG. 1, the electrolytic solution is filled into a space in the battery can 11. The electrolytic solution is a non-aqueous electrolytic solution containing an electrolyte salt and a non-aqueous solvent for dissolving the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

Examples of the solvent include non-aqueous solvents including lactone-based solvents such as γ-butyrolactone, γ-valerolactone, δ-valerolactone, and ε-caprolactone, carbonate-based solvents such as ethylene carbonate, propylene carbonate, butylene carbonate, vinylene carbonate, dimethyl carbonate, ethyl methyl carbonate, and diethyl carbonate, ether-based solvents such as 1,2-dimethoxyethane, 1-ethoxy-2-methoxyethane, 1,2-diethoxyethane, tetrahydrofuran, and 2-methyltetrahydrofuran, nitrile-based solvents such as acetonitrile, sulfolane-based solvents, phosphoric acids, phosphoric acid ester solvents, and pyrrolidones.

The electrolytic solution may further contain an additive such as a fluorinated carboxylic acid ester, a sulfonic acid ester, a sulfonic acid anhydride, and a carboxylic acid anhydride as an additive.

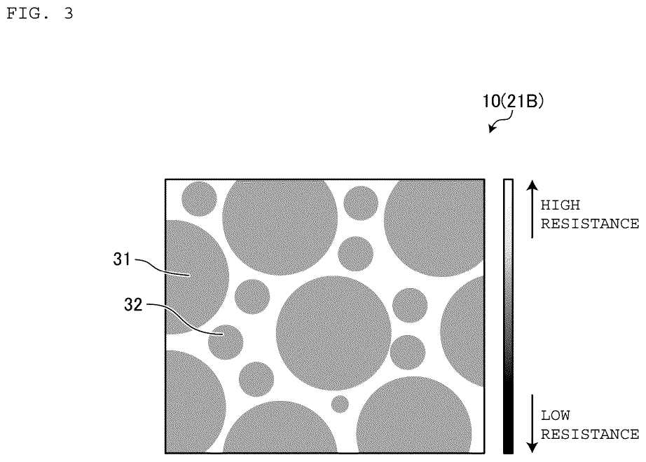

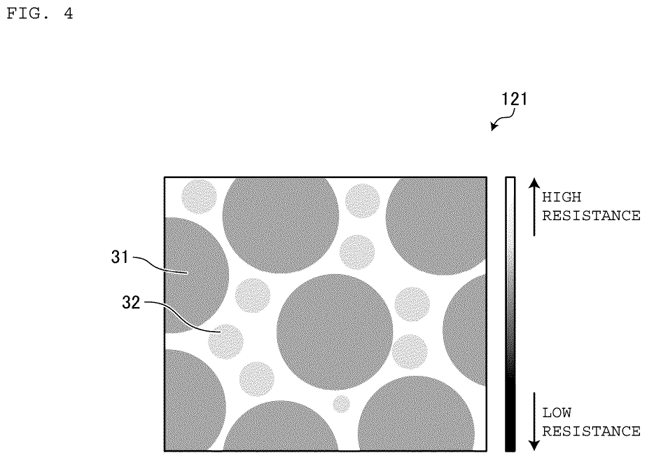

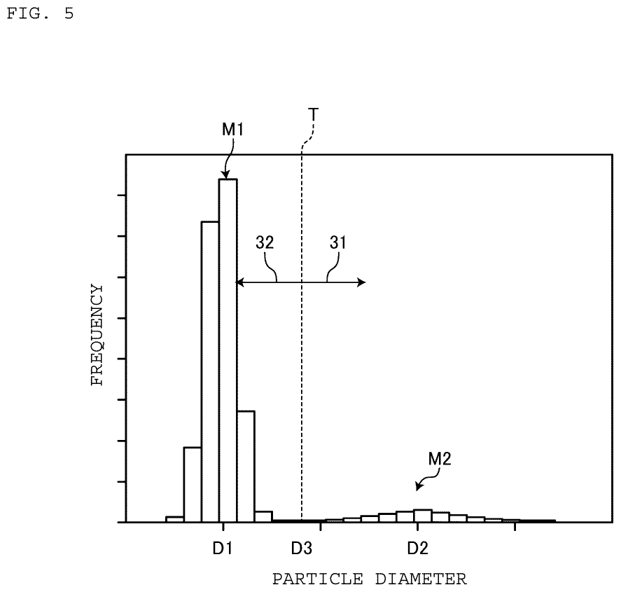

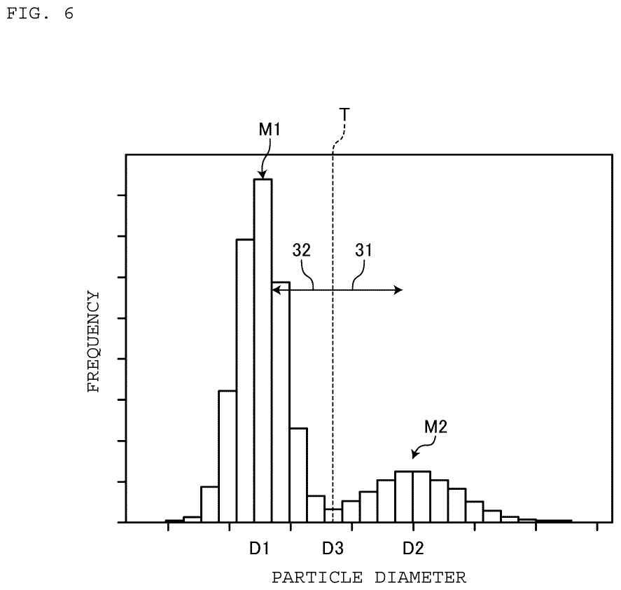

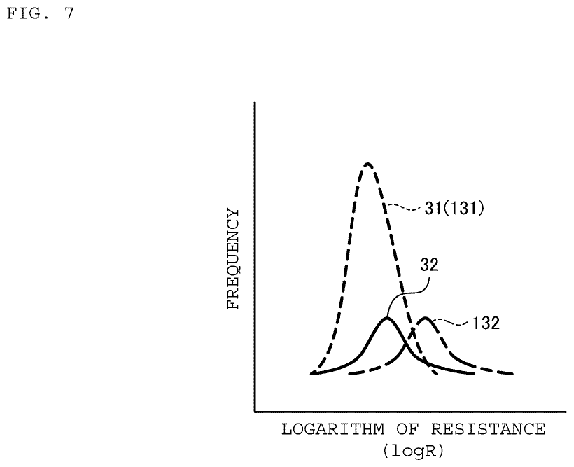

Next, a detailed configuration of the positive electrode active material contained in the positive electrode active material layer 21B will be described with reference to FIGS. 3 to 7. FIG. 3 is a schematic view illustrating a section of the positive electrode active material layer according to an embodiment. FIG. 4 is a schematic view illustrating a section of a positive electrode active material layer according to a comparative example. FIG. 5 is an explanatory view for explaining the particle size distribution of the positive electrode active material according to an embodiment. FIG. 6 is an explanatory view for explaining another example of the particle size distribution of the positive electrode active material according to an embodiment. FIG. 7 is a graph schematically showing the resistance distributions of first particles and second particles according to an embodiment and the comparative example.

FIGS. 3 and 4 schematically show sections measured using a scanning spreading resistance microscope (SSRM). Specifically, the measurement was performed under conditions of a scan rate of 0.2 Hz and a scan speed of 16 μm/s in an Ar atmosphere using Dimension ICON manufactured by Bruker Corporation.

The schematic views of FIGS. 3 and 4 are displayed such that the luminance varies depending on the resistance value. That is, in FIGS. 3 and 4, a higher luminance (closer to white) indicates a higher resistance, and a lower luminance (closer to black) indicates a lower resistance.

As shown in FIG. 3, the positive electrode active material according to an embodiment includes a plurality of first particles 31 having a relatively large average particle diameter and a plurality of second particles 32 having an average particle diameter smaller than that of the first particles 31. The first particles 31 and the second particles 32 each contain a nickel-based positive electrode active material.

In the measurement of the particle diameters of the first particles 31 and the second particles 32, a section is processed by ion milling in a discharged state of the positive electrode 21, and the section is observed. For the observation of the section of the positive electrode 21, 3 fields of view of each sample were imaged at an angle of view of 40 μm×40 μm. Then, the area of each particle is calculated from the image analysis of the image obtained by observation of the section. Assuming a circle having the same area as the area of the particle, the diameter of the circle is defined as the particle diameter.

As shown in FIGS. 5 and 6, the positive electrode active material according to an embodiment has a bimodal particle size distribution having a first mode M1 and a second mode M2. A particle diameter D1 of the first mode M1 is smaller than a particle diameter D2 of the second mode M2 (D1<D2). A particle diameter D3 having the least frequency between the first mode M1 and the second mode M2 is defined as a boundary T. Particles equal to or larger than the particle diameter D3 (boundary T) are defined as the first particles 31, and particles smaller than the particle diameter D3 (boundary T) are defined as the second particles 32.

In an embodiment, the particle diameter of the first particles 31 is 8 μm or more, and the particle diameter of the second particles 32 is smaller than 8 μm.

The positive electrode active material of a positive electrode 121 according to the comparative example shown in FIG. 4 includes a plurality of first particles 131 and a plurality of second particles 132 having an average particle diameter smaller than that of the first particles 131, similarly to an embodiment. Also in the comparative example, the particle diameter of the first particles 131 is 8 μm or more, and the particle diameter of the second particles 132 is smaller than 8 μm.

In the positive electrode active material according to an embodiment shown in FIG. 3, the positive electrode conductive aid is uniformly attached to the surfaces of the first particles 31 and the second particles 32. On the other hand, in the positive electrode active material according to the comparative example shown in FIG. 4, the adhesion of the positive electrode conductive aid is non-uniform, and the adhesion of the positive electrode conductive aid to the second particles 132 having a small particle diameter is insufficient.

As a result, as shown in FIG. 4, in the comparative example, the variation between the resistance values of the first particles 131 and the resistance values of the second particles 132 increases. More specifically, among the second particles 132, the second particles 132 to which the positive electrode conductive aid is insufficiently attached have high resistances, and have higher resistances than the first particles 131.

On the other hand, in the positive electrode active material according to an embodiment shown in FIG. 3, the variation between the resistance values of the first particles 31 and the resistance values of the second particles 32 is suppressed. That is, as compared with the comparative example, the luminance of the first particles 31 and the luminance of the second particles 32 illustrated in FIG. 3 have small variations. In addition, a local increase in resistance among the second particles 32 is suppressed.

The horizontal axis of the graph of FIG. 7 represents the resistance of the first particles 31 and 131 and the second particles 32 and 132. The vertical axis of the graph of FIG. 7 represents the frequency of particles.

In the measurement of the resistance of the first particles 31 and 131 and the second particles 32 and 132, the contours of the particles in the SSRM images of FIGS. 3 and 4 are extracted using image analysis software, and the luminance of each particle is quantified to calculate the resistance.

Next, the logarithms (log R) of the resistances and the average value of the logarithms (log R) of the resistances are calculated for each of the first particles 31 and 131 and the second particles 32 and 132 according to the definitions (particle diameters) of the first particles 31 and 131 and the second particles 32 and 132 described above. Note that the relationship between the luminance of the SSRM image and the resistance (more specifically, the logarithm (log R) of the resistance) is set in advance in the scanning spreading resistance microscope used for the measurement.

As shown in FIG. 5, in the comparative example, the logarithms (log R2) of the resistances of the second particles 132 are distributed on the high resistance side as compared with the logarithms (log R1) of the resistances of the first particles 131. On the other hand, in an embodiment, the logarithms (log R2) of the resistances of the second particles 32 are distributed in the resistance range substantially overlapping the logarithms (log R1) of the resistances of the first particles 31. In addition, the logarithms (log R2) of the resistances of the second particles 32 according to an embodiment are distributed on the lower resistance side than the logarithms (log R2) of the resistances of the second particles 132 according to the comparative example.

As described above, in the positive electrode active material according to an embodiment, it has been shown that the increase in resistance of the second particles 32 is suppressed, and the variation between the resistance values of the first particles 31 and the resistance values of the second particles 32 is suppressed. As a result, the positive electrode 21 of an embodiment suppresses the occurrence of a portion locally having a high potential during charging or the like. As a result, the secondary battery 10 can improve battery characteristics such as improvement of a cycle capacity retention rate and suppression of the increase in resistance.

### EXAMPLES

Hereinafter, examples will be described according to an embodiment. It is noted that the present disclosure is not limited to the following examples.

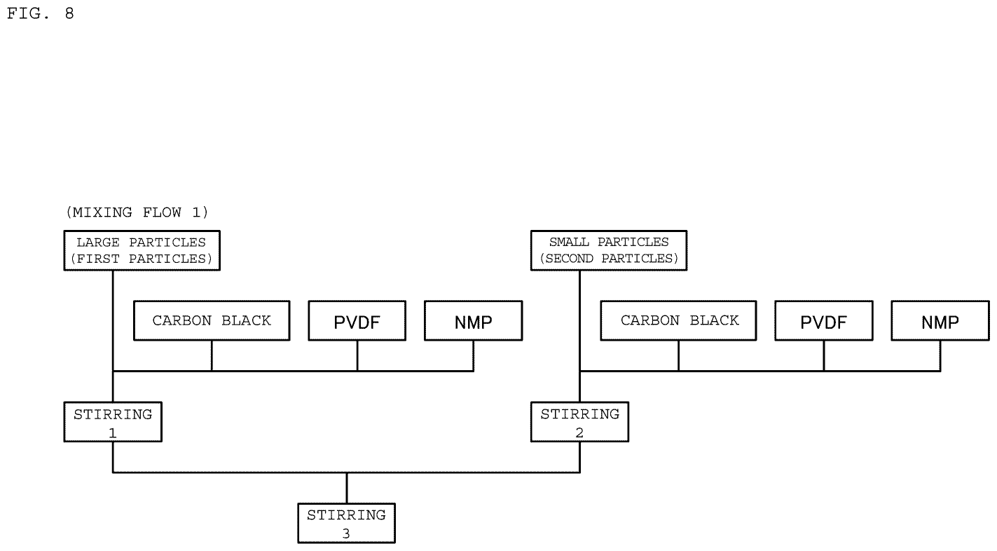

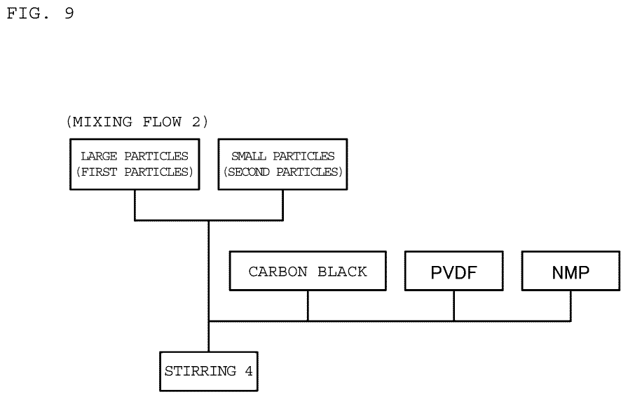

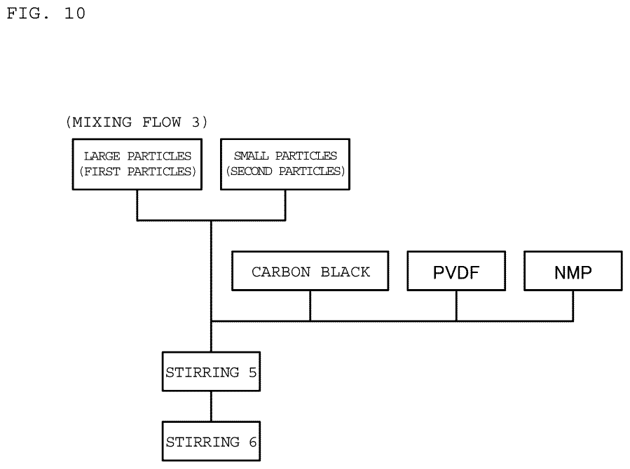

FIG. 8 is a flowchart for explaining a method for producing a positive electrode active material layer according to Examples 1 and 2. FIG. 9 is a flowchart for explaining a method for producing a positive electrode active material layer according to Comparative Example 1. FIG. 10 is a flowchart for explaining a method for producing a positive electrode active material layer according to Comparative Example 2.

The positive electrode active material according to Examples 1 and 2 was prepared according to mixing flow 1 shown in FIG. 8. In Examples 1 and 2, lithium nickel cobalt manganate (NCM) was used for both the first particles and the second particles. The ratio (mass ratio) between the first particles and the second particles was set to first particles/second particles=7/3.

As shown in FIG. 8, in Examples 1 and 2, the first particles, carbon black as a positive electrode conductive aid, polyvinylidene fluoride (PVDF) as a positive electrode binder, and N-methylpyrrolidone (NMP) as a solvent are stirred using a homogenizer (stirring 1).

In stirring 1, stirring was performed at a rotation speed of 3,000 rpm for 15 minutes. In addition, stirring 2 and stirring 3 described below were also performed under the same conditions.

In a process different from stirring 1, the second particles, carbon black as a positive electrode conductive aid, polyvinylidene fluoride (PVDF) as a positive electrode binder, and N-methylpyrrolidone (NMP) as a solvent are stirred using a homogenizer (stirring 2).

The slurries mixed in each of stirring 1 and stirring 2 are stirred using a homogenizer (stirring 3). As a result, a slurry containing the first particles and the second particles is formed.

The positive electrode mixture slurry obtained in stirring 3 was uniformly applied to a strip-shaped aluminum foil (positive electrode current collector) to form coating. Next, the coating was dried with hot air, and then subjected to compression molding with a roll press machine to form a positive electrode sheet having a positive electrode active material layer. The prepared positive electrode sheet was punched into a predetermined shape, and vacuum-dried using a vacuum dryer to obtain positive electrodes according to Examples 1 and 2.

Example 1 is different from Example 2 in that the amount of the positive electrode conductive aid charged together with the second particles in stirring 2 is large. However, the total amount of the positive electrode conductive aid charged in stirring 1 and stirring 2 is the same in Examples 1 and 2. That is, the composition of the slurry obtained in stirring 3 in Example 1 is the same as the composition of the slurry obtained in stirring 3 in Example 2.

The positive electrode active material according to Comparative Example 1 was prepared according to mixing flow 2 shown in FIG. 9. As shown in FIG. 9, in Comparative Example 1, unlike Examples 1 and 2, the first particles and the second particles are simultaneously stirred in one step. That is, in Comparative Example 1, carbon black as a positive electrode conductive aid, polyvinylidene fluoride (PVDF) as a positive electrode binder, and N-methylpyrrolidone (NMP) as a solvent are added to the first particles and the second particles, and the mixture is stirred using a homogenizer (stirring 4).

The positive electrode active material according to Comparative Example 2 was prepared according to mixing flow 3 shown in FIG. 10. As shown in FIG. 10, Comparative Example 2 is different from Comparative Example 1 in that the number of times of stirring is increased to twice. That is, in Comparative Example 2, carbon black as a positive electrode conductive aid, polyvinylidene fluoride (PVDF) as a positive electrode binder, and N-methylpyrrolidone (NMP) as a solvent are added to the first particles and the second particles, and the mixture is stirred using a homogenizer (stirring 5). Thereafter, the slurry obtained in stirring 5 is further stirred using a homogenizer (stirring 6).

For each of Examples 1 and 2 and Comparative Examples 1 and 2, a coin cell was produced, and the results of evaluating the average value of the logarithms (log R1) of the resistances of the first particles 31 of the positive electrode 21, the average value of the logarithms (log R2) of the resistances of the second particles 32, the ratio (log R2/log R1) of the logarithms of the resistances, and the cycle retention rate of the coin cell are shown in Table 1.

The logarithms of the resistances of the first particles and the second particles were calculated on the basis of the SSRM image by the method described referring to FIGS. 3 to 7. As the cycle retention rate of the coin cell, the capacity retention rate (=discharge capacity at 100^{th} cycle/discharge capacity at 1^{st} cycle) was calculated for each of Examples 1 and 2 and Comparative Examples 1 and 2. In Table 1, values normalized with the capacity retention rate of Example 1 as 100 are shown.

TABLE 1

| | | First | Second | Resistance | Cycle |
|---|---|---|---|---|---|
| Experimental | Mixing | particles | particles | ratio | retention |
| example | flow | logR1 | logR2 | (logR2/logR1) | rate |
| Example 1 | 1 | 6.88 | 7.62 | 1.11 | 100 |
| Example 2 | 1 | 6.72 | 8.01 | 1.25 | 99 |
| Comparative | 2 | 6.59 | 8.59 | 1.30 | 94 |
| Example 1 | | | | | |
| Comparative | 3 | 6.65 | 8.71 | 1.35 | 95 |
| Example 2 | | | | | |

As shown in Table 1, in all of Examples 1 and 2 and Comparative Examples 1 and 2, the logarithms (log R2) of the resistances of the second particles are larger than the logarithms (log R1) of the resistances of the first particles. The logarithms (log R1) of the resistances of the first particles in Examples 1 and 2 are larger than the logarithms (log R1) of the resistances of the first particles in Comparative Examples 1 and 2. The logarithms (log R2) of the resistances of the second particles in Examples 1 and 2 are smaller than the logarithms (log R2) of the resistances of the second particles in Comparative Examples 1 and 2. That is, in Examples 1 and 2, the difference between the logarithms (log R1) of the resistances of the first particles and the logarithms (log R2) of the resistances of the second particles is smaller than in Comparative Examples 1 and 2.

The ratios (log R2/log R1) of the logarithms of the resistances (R1) of the first particles and the resistances (R2) of the second particles in Examples 1 and 2 are smaller than the ratios of the logarithms of the resistances in Comparative Examples 1 and 2. Specifically, the ratios (log R2/log R1) of the logarithms of the resistances in Examples 1 and 2 are 1.25 or less. On the other hand, the ratios (log R2/log R1) of the logarithms of the resistances in Comparative Examples 1 and 2 are 1.30 or more.

Comparing Example 1 with Example 2, the logarithm (log R2) of the resistance of the second particles in Example 1 is smaller than that in Example 2. The ratio (log R2/log R1) of the logarithms of the resistances in Example 1 is smaller than that in Example 2. As a result, it was shown that also when the total amount of the positive electrode conductive aid is the same, the resistance of the second particles can be effectively suppressed by relatively increasing the amount of the positive electrode conductive aid charged together with the second particles in stirring 2 (see FIG. 8).

Comparing Comparative Example 1 with Comparative Example 2, the logarithm (log R2) of the resistance of the second particles in Comparative Example 1 is smaller than that in Comparative Example 2. The ratio (log R2/log R1) of the logarithms of the resistances in Comparative Example 1 is smaller than that in Comparative Example 2. Thus, only by increasing the number of times and time of stirring, the positive electrode conductive aid is unevenly attached to the surfaces of the first particles having large particle diameters, and it can be said that the effect of suppressing the resistance of the second particles is small.

The cycle retention rates in Examples 1 and 2 are higher than those in Comparative Examples 1 and 2. Specifically, the cycle retention rate in Example 2 maintains a value of 99 or more when standardized with Example 1 as a reference (100). On the other hand, the cycle retention rates of Comparative Examples 1 and 2 are 95 or less.

As described above, in Examples 1 and 2, by separately stirring the first particles and the second particles in stirring 1 and stirring 2 (see FIG. 8), respectively, the positive electrode conductive aid is uniformly attached to the surfaces of the first particles and the second particles. As a result, it was shown that in Examples 1 and 2, an increase in resistance of the second particles can be suppressed as compared with Comparative Examples 1 and 2. In addition, it was shown that Examples 1 and 2 had higher cycle retention rates than Comparative Examples 1 and 2.

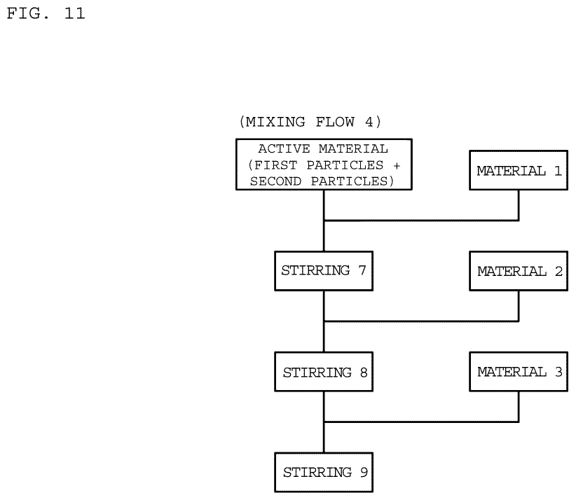

FIG. 11 is a flowchart for explaining a method for producing a positive electrode active material layer according to Examples 3, 4, 5, and 6 and Comparative Examples 3 and 4.

Table 2 shows the order of addition of materials and stirring conditions for Examples 3, 4, 5, and 6 and Comparative Examples 3 and 4. For each of Examples 3, 4, 5, and 6 and Comparative Examples 3 and 4, a coin cell was produced, and the results of evaluating the average value of the logarithms (log R1) of the resistances of the first particles of the positive electrode, the average value of the logarithms (log R2) of the resistances of the second particles, the ratio (log R2/log R1) of the logarithms of the resistances, and the cycle retention rate of the coin cell are shown in Table 2.

As shown in FIG. 11 and Table 2, in Examples 3, 4, 5, and 6 and Comparative Examples 3 and 4, the orders of addition of carbon black (CB) as a positive electrode conductive aid, carbon nanotubes (CNT), and polyvinylidene fluoride (PVDF) as a positive electrode binder to the first particles and the second particles are different from each other.

As shown in FIG. 11, a first material (hereinafter referred to as material 1) selected from CB, CNT, and PVDF is added to the first particles and the second particles, and the mixture is stirred using a homogenizer (stirring 7). As a solvent, N-methylpyrrolidone (NMP) was used in the same manner as in Examples 1 and 2 described above.

Next, a second material (hereinafter referred to as material 2) selected from CB, CNT, and PVDF excluding the material 1 is added to the slurry obtained in stirring 7, and the mixture is stirred using a homogenizer (stirring 8).

Next, a third material (hereinafter referred to as material 3) from among CB, CNT, and PVDF excluding the materials 1 and 2 is added to the slurry obtained in stirring 8, and the mixture is stirred using a homogenizer (stirring 9).

Using the positive electrode mixture slurry obtained in stirring 9, positive electrodes according to Examples 3, 4, 5, and 6 and Comparative Examples 3 and 4 were obtained in the same manner as in Example 1. The order of addition of CB, CNT, and PVDF (material 1, material 2, and material 3) and the stirring conditions of stirring 7, stirring 8, and stirring 9 in each of Examples 3, 4, 5, and 6 and Comparative Examples 3 and 4 are as shown in Table 2.

TABLE 2

| | | | | Stirring 7 | | Stirring 8 | |
|---|---|---|---|---|---|---|---|
| | Order of addition of | | | conditions | | conditions | |
| | materials | | | Rotation | | Rotation | |
| Experimental | Material | Material | Material | speed | Time | speed | Time |
| example | 1 | 2 | 3 | (rpm) | (min) | (rpm) | (min) |
| Example 3 | CB | PVDF | CNT | 3000 | 15 | 2000 | 30 |
| Example 4 | PVDF | CNT | CB | 3000 | 15 | 2000 | 15 |
| Example 5 | CB | PVDF | CNT | 2000 | 30 | 3000 | 15 |
| Example 6 | PVDF | CB | CNT | 2000 | 30 | 3000 | 15 |
| Comparative | CB | CNT | PVDF | 2000 | 15 | 3000 | 15 |
| Example 3 | | | | | | | |
| Comparative | PVDF | CNT | CB | 2000 | 15 | 3000 | 15 |
| Example 4 | | | | | | | |

| | Stirring 9 | | | | | |
|---|---|---|---|---|---|---|
| | conditions | | | | | |
| | Rotation | | First | Second | Resistance | Cycle |
| Experimental | speed | Time | particles | particles | ratio | retention |
| example | (rpm) | (min) | logR1 | logR2 | (logR2/logR1) | rate |
| Example 3 | 2000 | 15 | 5.75 | 6.09 | 1.06 | 100 |
| Example 4 | 2000 | 30 | 5.80 | 6.31 | 1.09 | 99 |
| Example 5 | 2000 | 15 | 5.85 | 6.32 | 1.08 | 99 |
| Example 6 | 2000 | 15 | 5.78 | 6.01 | 1.04 | 100 |
| Comparative | 2000 | 30 | 5.99 | 7.65 | 1.28 | 93 |
| Example 3 | | | | | | |
| Comparative | 2000 | 30 | 5.95 | 7.50 | 1.26 | 95 |
| Example 4 | | | | | | |

As shown in Table 2, the logarithms (log R2) of the resistances of the second particles in Examples 3, 4, 5, and 6 are smaller than the logarithms (log R2) of the resistances of the second particles in Comparative Examples 3 and 4. The ratios (log R2/log R1) of the logarithms of the resistances (R1) of the first particles and the resistances (R2) of the second particles in Examples 3, 4, 5, and 6 are smaller than the ratios (log R2/log R1) of the logarithms of the resistances in Comparative Examples 3 and 4. Specifically, the ratios (log R2/log R1) of the logarithms of the resistances in Examples 3, 4, 5, and 6 are 1.25 or less. More specifically, the ratios (log R2/log R1) of the logarithms of the resistances in Examples 3, 4, 5, and 6 are 1.09 or less. On the other hand, the ratios (log R2/log R1) of the logarithms of the resistances in Comparative Examples 3 and 4 are 1.28 or more.

The cycle retention rates in Examples 3, 4, 5, and 6 are higher than those in Comparative Examples 3 and 4. Specifically, the cycle retention rates in Examples 4, 5, and 6 maintain values of 99 or more when standardized with Example 3 as a reference (100). On the other hand, the cycle retention rates of Comparative Examples 3 and 4 are 95 or less.

As described above, in Examples 3, 4, 5, and 6, it was shown that by appropriately setting the order of addition of CB, CNT, and PVDF and the stirring conditions of stirring 7, stirring 8, and stirring 9, the positive electrode conductive aid uniformly adheres to the surfaces of the first particles and the second particles, and the increase in resistance of the second particles can be suppressed as compared with Comparative Examples 3 and 4. More specifically, in Examples 3, 4, 5, and 6, the conductive paths around the small particles are improved and the difference in resistance between the large and small particles is reduced as compared with Comparative Examples 3 and 4 by devising the slurry mixing process. As a result, in Examples 3, 4, 5, and 6, deterioration due to non-uniformity of the resistances can be suppressed, and the cycle capacity retention rate and the resistance increase can be improved.

It is to be noted that an embodiment described above is intended to facilitate understanding of the present disclosure, but not intended to construe the present disclosure in any limited way. The present disclosure can be modified or improved without departing from the gist thereof, and equivalents thereof are also included in the present disclosure.

The present disclosure includes the following configurations according to an embodiment:

(1) A positive electrode including
a positive electrode active material containing a plurality of first particles and a plurality of second particles having an average particle diameter smaller than an average particle diameter of the plurality of first particles,
letting a resistance of the plurality of first particles be R1 and a resistance of the plurality of second particles be R2 as measured using a scanning spreading resistance microscope,
a ratio (log R2/log R1) of logarithms of the resistance (R1) of the plurality of first particles and the resistance (R2) of the plurality of second particles is 1.25 or less.

(2) The positive electrode according to (1),
in which a particle diameter of the plurality of first particles is 8 μm or more, and
a particle diameter of the plurality of second particles is smaller than 8 μm.

(3) A secondary battery including:
the positive electrode according to (1) or (2);
a negative electrode; and
an electrolyte.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode comprising
a positive electrode active material including a plurality of first particles and a plurality of second particles having an average particle diameter smaller than an average particle diameter of the plurality of first particles,
wherein, a resistance of the plurality of first particles is R1 and a resistance of the plurality of second particles is R2 as measured using a scanning spreading resistance microscope, and
wherein a ratio (log R2/log R1) of logarithms of the resistance (R1) of the plurality of first particles and the resistance (R2) of the plurality of second particles is 1.25 or less.

2. The positive electrode according to claim 1,
wherein a particle diameter of the plurality of first particles is 8 μm or more, and
a particle diameter of the plurality of second particles is smaller than 8 μm.

3. A secondary battery comprising:
the positive electrode according to claim 1;
a negative electrode; and
an electrolyte.
